(19) United States
(12) Patent Application Publication
(10) Pub. No.: US 2004/0158855 A1
(43) Pub. Date: Aug. 12, 2004

(54) Systems and applications for delivering multimedia contents and programs to interact with communication devices and display devices

(76) Inventors: Yihong Gu, Cupertino, CA (US); Ying Lee, Mountain View, CA (US)

Correspondence Address: Bo-In Lin, 13445 Mandoli Drive, Los Altos Hills, CA, 94022, US

(21) Appl. No.: 10/703,270

(22) Filed: Nov. 6, 2003

Related U.S. Application Data
(60) Provisional application No. 60/446,460, filed on Feb. 10, 2003.
(60) Provisional application No. 60/466,460, filed on Apr. 29, 2003.

(51) Int. Cl. H04Q 7/20; H04N 7/18; G06F 13/00; H04N 5/445

(52) U.S. Cl. 725/39; 725/61; 455/403; 725/81

(57) ABSTRACT

The present invention discloses a system configuration and method to reformat and transmit the TV multimedia signals and electronic program guide as broadcast, multicast, transmission-on-demand or interactive transmission signals using a broad varieties of data formats and signal communication protocols to personal mobile or telephonic devices. The TV multimedia signals and program schedule data as previously available only for use and display on TV can now be flexibly and conveniently received, processed, and enjoyed by more kinds of personal mobile and/or telephonic devices which can in turn navigate, interact and exchange information with the display devices.

This application claims priority to pending U.S. provisional patent application entitled SYSTEMS AND METHODS FOR DELIVERING MULTIMEDIA CONTENTS AND PROGRAMS TO COMMUNICATION DEVICES filed Apr. 29, 2003 by Guo and accorded Serial No. 60/446,460, the benefit of its filing date being hereby claimed under Title 35 of the United States Code.

### BACKGROUND OF THE INVENTION

1. Field of the Invention

This invention relates generally to systems and methods to deliver multimedia contents and TV program guides of broadcasting, multicasting, and unicasting the multimedia contents. More particularly this invention is related to systems and applications to deliver and interact with multimedia contents related to TV program guides to communication devices capable of processing digitized data and displaying multimedia signals.

2. Description of the Prior Art

Even though there are wide varieties of multimedia TV programs and electronic program guides related to the schedules of these multimedia programs, the reception and display of these multimedia contents and program information are still mostly limited to the televisions and devices connected to TV signal receivers. Even that some of the electronic program guide (EPG) information is receivable by a mobile communication device; there are still limitations that the EPG are only transmitted as broadcasting signal in limited text format with little graphics. Furthermore, there are limitations that even the EPG is received as broadcasting signals as data by some mobile devices, a user is still not provided with interactive options to select, command and navigate the display, retransmissions, download, and repurpose of the multimedia signals transmitted through multiple channels such that a user can take full advantages of video on demand and interactive features provided by modern technologies. The limitations had greatly restricted the usefulness and market potential of the multimedia contents and program information received by terminal devices, especially in view of the rapid technological innovations and growth of numerous terminal devices such as cellular phones and wireless-connected PDAs (personal digital assistant devices), which now are equipped with colored image display screens and the capability of wireless data communications.

Sano et al. disclose in a Patent Application US2202/0059596 entitled “Device and Method for Distributing Program Information and Terminal and Device Relating to the Same”, the techniques to allow the electronic program guide (EPGs) to be viewed and desired programs to be recorded remotely from the associated receiver. In one of the embodiments, Sano's system converts digital broadcasted information including program information so that a handheld device can receive program information and further provides the handheld remote device to control a recording device through a connected network to record a broadcast program based on the program information. While Sano's system provide handheld program with limited control to command a remote receiver and/or recording device to record a selected program, Sano's techniques are limited by a passive mode of operations that a user of the wireless device can only receive broadcasted program guides with limited program selections from the broadcasting channels. The users of Sano's techniques are still limited by the restrictions that a user is not provided with sufficient proactive command capabilities to select, interact, navigate and demand the selections, receptions, recording and showing of the user selected programs through multiple kinds of signal transmissions using a wireless communicating device.

Shimakawa et al. disclose in a U.S. Pat. No. 6,452,644, entitled “Method of Controlling Reception in Data Broadcast Receiver”, a mobile data receiver to receive a desired type of data, for example, weather forecasts, news, stock prices, etc. The system provides the transmission of time information, which specifies, for each type of data, when the data will be transmitted or retransmitted. This allows the receiver to enter a standby mode in which the power consumption is reduced. On, or slightly before, the specified time, the receiver switches on to receive, decode and display the desired data. The invention is also applicable in television receivers having the facility to receive electronic program guides (EPG) or other services. The receiver is informed about the time at which an updated version of the EPG can be expected. In order to reduce power consumption in the receiver's standby mode, the hardware for receiving the EPG is not activated until the specified instant of time. Although the patented disclosures are useful to reduce power consumptions for the remote terminal devices by automatically controlling transmission time/schedule to save power, the system and method provided by Shimakawa et al. is limited by the passive mode of operations, restrictive channels of broadcasting transmissions. The receiving device of the EPG data is further limited to a television and the EPG data does not provide multimedia display to allow user to interactively select and command the reception of multimedia data and signals.

Hiramoto et al. disclose in a published Patent Application 20030023987, entitled “Program recording system, remote controller, and method and program for remote control” a mobile telephone to acquire the recording reservation information and information of broadcasting schedule and to display points of difference between the recording reservation information and the information of the broadcasting schedule to match the contents and update the changes. Hiramoto's invention is useful for identifying differences between the EPG and the broadcast schedule. However, Hiromoto's invention is limited by not providing the interactivity between a terminal device including a telephonic device or a mobile communicating device and a video-enabled appliance now made available by modern technologies.

Nagaoka et al. disclose in a published Patent Application 20020092024, entitled “Method for provision of program and broadcasting system and server”, a system to enable the participation of a large number of widely dispersed viewers in an auction program while maintaining a real time feeling of the program. A broadcast station broadcasts program data of a pre-recorded auction program and report information data and EPG data for the information to be reported to the viewers in the program multiplexed as broadcast data. A TMS system receives the broadcast data broadcast from the broadcast station and distributes it to mobile phones. When the users of the mobile phones input bids etc. for the auction while viewing the program, the mobile phones transmit input price information to the TMS. The TMS transfers the input price information to the broadcast station, and the broadcast management server of the broadcast station updates the report based on the information. While the system is useful for auctioning programs and can further provide EPG data to the mobile phones, the system does not allow the interactions and commanding capabilities for a user to receive and enjoy the multimedia programs through multi-channel signal transmissions based on a video on demand platform.

There is still a gap in the art of television signal transmission and reception to provide systems and methods to convert the multimedia contents and program schedule information into signals for transmission more than just broadcasting channels as multimedia and interactive telephonic and mobile data signals. There is still a need in the art to provide novel and improve technologies so that the terminal devices, either the wired or wireless devices, can receive, process and allow user to select, command and navigate signal retransmission and repurpose in order to display and make use of TV content and TV program signals to fully utilize and transmit the multimedia contents and the program schedule information by a user of a stationary or mobile terminal device.

### SUMMARY OF THE PRESENT INVENTION

It is therefore the object of the present invention to advance the art by providing systems and methods to enable the telephonic devices or mobile data devices to receive the broadcasted, multicasted, or on-demand TV multimedia and program schedule signals and allow interactivity between the telephonic or mobile data devices and the video displaying devices such that the limitations as now encountered by the art can be overcome.

Specifically, it is an object of the present invention to provide a system configuration and method to produce and transmit multimedia TV signals and program schedule data to wide varieties of mobile and telephonic devices to broaden the scopes of signal transmission and display of previously limited usefulness of TV signals and program schedule information.

It is another object of this invention to personalize and to make more convenient the display and enjoyment of TV signals and program schedule data by transmitting these signals to personal mobile and/or telephonic devices as these devices are now provided with more display, storage, forward-transmission and other multimedia features.

It is another object of this invention to allow more interactive selection and multimedia functions by transmitting TV signals and program schedule data to personal mobile and/or telephonic devices as these devices are now provided with interactive communication and control functions for interactively using and responding to the multimedia information.

It is another object of this invention to broaden the use of the personal mobile and telephonic devices to receive broadcast, multicast, on-demand or interactive signals that may have different formats and transmitted by using different protocols, such that the users are provided with broader scopes of signals with enriched contents taking full advantages provided by modern communication technologies.

It is another object of this invention to broaden the use of the personal mobile and telephonic devices by enabling the devices to receive electronic program guides as TV program schedule data and to use these devices, such as a PDA, a mobile phone, or other telephonic or mobile device as a set-top box such that a viewer does not need a separate set-top box to receive the electronic program guide.

It is another objective of this invention to expand the scope of interaction between personal mobile or telephonic devices and the video displaying devices such that the personal mobile or telephonic devices can control, navigate, and interact with the video displaying device.

Briefly, the present invention discloses a multimedia television program data transmission system that includes a means for reformatting a TV signal into another format suitable for display by a personal communication device.

### BRIEF DESCRIPTION OF THE DRAWINGS

FIG. 1 is a system functional diagram for showing the transmission and reception of TV multimedia and program schedule signals by personal mobile and/or telephonic devices according to the system architecture of this invention.

FIG. 2 is a process flow diagram for illustrating the steps carried out in a system implementation for a specific preferred embodiment of this invention.

### DETAILED DESCRIPTION OF THE PREFERRED EMBODIMENT

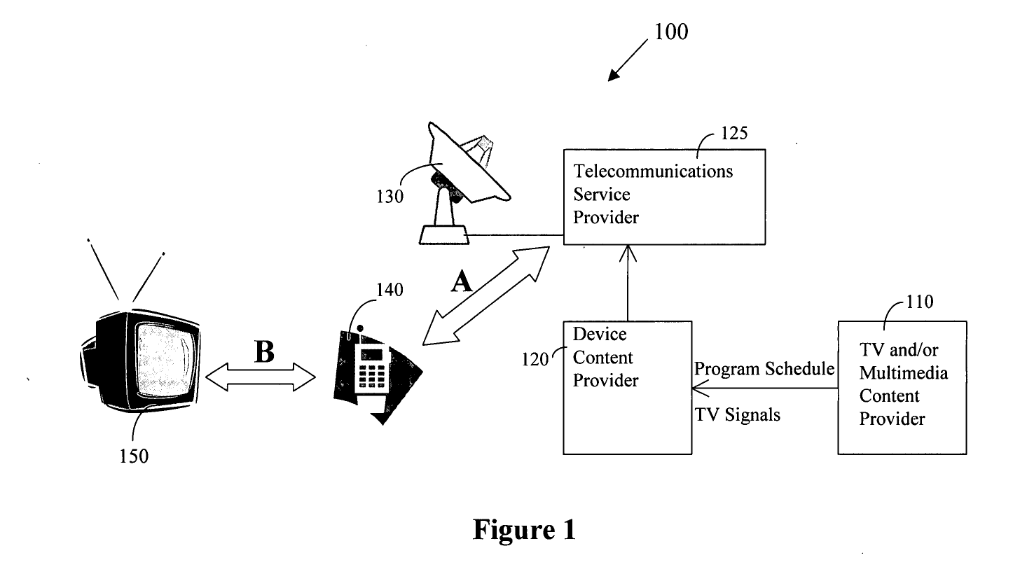

FIG. 1 depicts a system functional diagram of the architecture of signal transmission and reception of a system 100 for transmitting TV-multimedia and program schedule signals of this invention. A TV content provider and/or a multimedia content provider (such as a movie studio) 110 first generate the TV multimedia content (such as preview) and program schedule. Since the TV multimedia signals are provided in particular formats suitable for TV display, a device content provider 120 first reformats these signals such that the reformatted signals can be properly received and processed by designated mobile and telephonic devices such as a cellular phone of a PDA. The program guide data signals can be easily created in different formats independent of the TV multimedia signals, therefore, the reformatting process is probably not required to convert the program guide signals into device formats. The TV multimedia content signals and/or the program guide signals can be transmitted to a device content provider 120 either through data communications means (such as private lines) known to those skilled in the technology or as a physical delivery as a tape or through other modes or methods of content deliveries. The reformatted data can be in different image display formats for different display devices. The reformatted image data can be in JPEG, MPEG, bit-map, or other kinds of display formats suitable for image display on wide varieties of image display devices. The video/audio data can be reformatted for devices implemented with Real Player, Microsoft Media Player, H.264 or having variations of the MPEG format. The text messages can be in short message format or in WAP format. After the multimedia TV content or program schedule data are produced through the processes of reformatting, insertion of non-television contents, and mixing of applicable text, video and audio data. The data are then sent out to a telecommunications service provider 125 which operates signal transmission stations and signal relay stations 130 to transmit the data to a signal receiver 140 as broadcast, multicast, on-demand or interactive signals. The multimedia content transmission can be processed via WAP, Java or BREW. However, proprietary formats and technologies achieving similar objectives not covered by the aforementioned standards are also included.

Referring to FIG. 1 again, the personal communication of terminal device 140 can also be used as a remote control for TV, VCR and other consumer electronics display device 150. Meanwhile, the display device 150 can be used as a display for content on 140. Communication between 140 and 150 can be: Bluetooth, Home RF, Infrared, iSCSI, and WiFi. Different configurations of embodiments may be implemented in the present invention including but not limited to:

Display on 150 content received on 140

Using 140 to navigate on 150 based on program guide content received on 140

Program video recording on 150 using 140 with TV guide and schedule content received on 140

In the context of VOD and pay-per-view, a viewer can request TV programs using 140 instead of currently using a set-top box

The reformatted signals in proper formats are transmitted by the signal transmitter 130 through different signal transmission channels, either wireless or wired channels through different signal dispatching, relaying, and mobile carrier stations 130 to reach a receiver disposed on a personal communication device 140, e.g., a cellular phone, a wireless PDA or an telephone provided with image display function and connected through a telephone line. The signal transmissions may be carried out in different signal transmission protocols such as WAP, GPRS, CDMA1X, SMS for textual signals and various 3G wireless protocols, e.g., TDMA-based, and CDMA-based protocols.

The personal communication devices 140 are provided with different control functions to receive, process and display the reformatted TV multimedia and program schedule signals. As most of the mobile and telephonic devices are now provided with multimedia signal process capabilities, so long as the device 140 as a suitable format receives the signals, each mobile or telephonic device 140 can process and display or play the signals accordingly. A user of the mobile or telephonic device 140 can receive and use the TV program schedule, e.g., electronic program guide (EPG) and enabled to, display the selected TV programs on the personal communication devices, e.g., a cellular phone, a PDA, a pager, a GSM device, or other mobile or telephonic device. Moreover, since a mobile and telephonic device can also transmit signals, a user can interact with the mobile content provider 120, for example, to view specific content and guide information and send messages to the content provider.

The device content provider 120 and the telecommunication service provider 125 may be provided with functions for setting up a billing system to account for payments when a personal communication device user 140 receives and display reformatted TV programs or program schedule signals. The billing system may be implemented with either a subscriber system or a pay per use system.

A signal transmission system is disclosed in this invention that includes a means for transmitting a TV program guide to a personal communication device. In a preferred embodiment, the means for transmitting the TV program guide to a personal communication device further includes a means for transmitting the TV program guide to a mobile phone. In another preferred embodiment, the means for transmitting the TV program guide to a personal communication device further includes a means for transmitting the TV program guide to a personal digital assistant (PDA). In another preferred embodiment, the means for transmitting the TV program guide to a personal communication device further includes a means for transmitting the TV program guide to a networked communication device. In another preferred embodiment, the means for transmitting the TV program guide to a personal communication device further includes a means for transmitting the TV program guide to a telephonic device. In another preferred embodiment, the means for transmitting the TV program guide to a personal communication device further includes a means for keeping account and billing a transmission of the TV program guide to the personal communication device.

The implementation as shown in FIG. 1 can be divided into two major steps, i.e., steps A and B, as marked out in FIG. 1. In step A, two groups of telecommunication venues can be implemented, namely a wireless venue and a wireline venue. Implementation of the wireless venue can be carried out by various technologies based on wide varieties of wireless communication standard, including but not limited to standards of GSM, GPRS, EDGE, TDMA-based, CDMA-based, SMS, WAP, Satellite, PHS, and the upcoming 3G standards. Implementation of wireline transmissions can be carried out by transmitting the signals to an on-line device then implemented with different kinds of local interfaces. The wireline transmissions may be conducted through fiber, e.g., ATM, SONET, WDM, ePON, aPON), copper (including xDSL, HomePNA, and dial-up), Cable. Different kinds of on-line devices may be applied to receive the signals including but not limited to PC, server, AP, telephonic device. Broad spectrum of local interfaces can be implemented including but not limited to Wireless: WiMAX (802.16), Wifi (802.11a, b, g), PHS/PAS, Bluetooth and newly adopt wireless standards for PAN and LAN Wired: USB, IEEE serial/parallel standards. The signal transmission carried out in step A can be a unicast transmission, or can be a multicast with interactive features, a point-to-point on demand transmission, a peer-to-peer communication transmissions or combinations of the above and may include signal transmission modes enabled by future technologies.

Furthermore, the implementation of step B can also be carried out in wide varieties of technical approaches. The receiving device, e.g., a TV, can receive the signals either wireless of via a wired transmission. In a wireless operation, the TV can receive signals through a Personal Area Network-based signals, including Bluetooth, Home RF, Infrared, iSCSI, wifi, PHS/PAS as well as other wireless (short distance) transmission protocols defined above, or the signals can be transmitted through a wired signal cable. All of the above implementations can be either adapted to use stand-based technologies with published and public standards or can be deployed to apply proprietary technologies more suitable for different application environments and technology platforms to achieve the purposes of this invention.

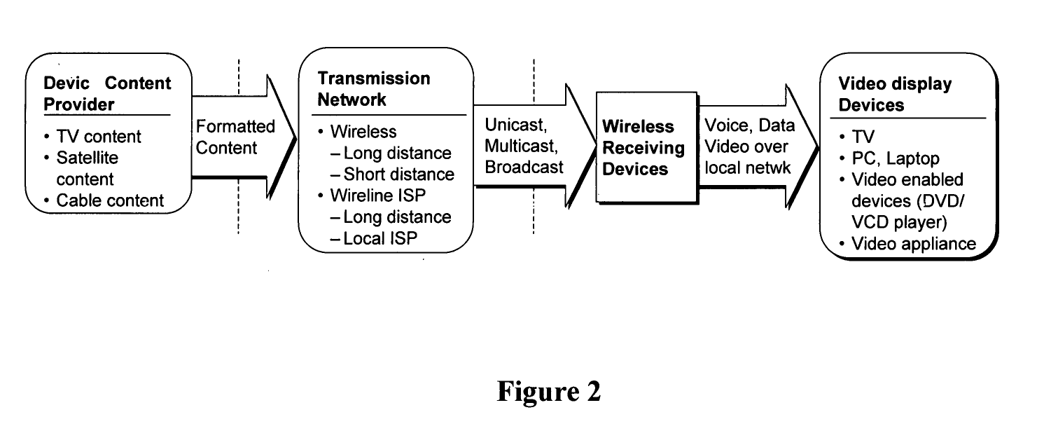

Referring to FIG. 2 for a conceptualized diagram of the processing steps disclosed by this invention. The device content provider 120 generates formatted content data that is suitable for personal wireless device or a terminal device from TV content, satellite content, and cable content data. The formatted data are transmitted through the transmission networks that may include wireless or wieline transmissions over short or long distances depending specific applications through unicast, multicast, or broadcast channels. A receiving-device 140, e.g., a wireless PDA receives the transmitted signals and then applies the signals received that includes audio, video and other kinds of multimedia data to navigate and interact with a video display device, such as a TV, PC, laptop computer, a video enabled device such as DVD or VCD player, or other kinds of video appliances to display and operate the data received. Also listed in FIG. 2 are also different kinds of formatted contents, wide varieties of wireless receiver devices, and different forms of audio, video and multimedia data.

Unlike the conventional technology that may be used for remotely recording broadcasting programs through a handheld device, the present invention allows for navigating, controlling and on-demand/interactive operation with both broadcast, unicast, multicast, as well as on-demand programs. As most of the prior art technology focused on broadcast transmission, the present invention takes advantage of modern technologies of signal transmission technologies to implement unicast, multicast, and on-demand/interactive transmission. As most of the prior art disclosures are focused on targeted TV signal, the present invention is implemented with transmission via wide-area/local-area wireless signals. Unlike many of the conventional application, the present invention does not require the receiving device to have a data recording capability because this invention further provides signal re-transmission and navigation functions and more flexible operations are allowed. The present invention further operates with digitized multimedia signals with wide latitudes for adapting to implementations of different formats, transmission, and repurpose operations. The configurations and mode of operations as disclosed in this invention thus takes advantages of the full extent of the advancements and platforms built on modern technologies in the signal processes, telecommunications, network and multimedia data management and processes.

According to above descriptions, this invention discloses a signal transmission system that includes a means for reformatting a TV signal into a format suitable for a personal communication device. In a preferred embodiment, the means for reformatting the TV signal further include a means for reformatting the TV signal into a MPEG signal. In another preferred embodiment, the means for reformatting the TV signal further include a means for reformatting the TV signal into a JPEG signal. In another preferred embodiment, the means for reformatting the TV signal further include a means for reformatting the TV signal into a bit-map signal. In another preferred embodiment, the means for reformatting the TV signal further include a means for reformatting the TV signal into a Real-Player signal. In another preferred embodiment, the means for reformatting the TV signal further include a means for reformatting the TV signal into a Microsoft Media-Player signal. In another preferred embodiment, the means for reformatting the TV signal further include a means for reformatting the TV signal into a short messaging (SMS) signal. In another preferred embodiment, the means for reformatting the TV signal further include a means for reformatting the TV signal into a WAP signal. In another preferred embodiment, the multimedia signal transmission system further includes a means for repurposing a multimedia TV segment for wireless data transmission. In another preferred embodiment, the multimedia signal transmission system further includes a means for repurposing a multimedia TV segment for a preview. In another preferred embodiment, the multimedia signal transmission system further includes a means for repurposing a multimedia TV segment for a preview or trailer. In another preferred embodiment, the multimedia signal transmission system further includes a means for creating a multimedia TV segment for describing another multimedia content. In another preferred embodiment, the multimedia signal transmission system further includes a means for creating a text-based message for describing a multimedia content. In another preferred embodiment, the multimedia signal transmission system further includes a protocol means for transmitting the TV signal using a WAP protocol. In another preferred embodiment, the multimedia signal transmission system further includes a protocol means for transmitting the TV signal using a SMS protocol. In another preferred embodiment, the multimedia signal transmission system further includes a protocol means for transmitting the TV signal using a GPRS protocol. In another preferred embodiment, the multimedia signal transmission system further includes a protocol means for transmitting the TV signal using a CDMA1X protocol. In another preferred embodiment, the multimedia signal transmission system further includes a protocol means for transmitting the TV signal using a 3G (third generation) wireless protocol. In another preferred embodiment, the multimedia signal transmission system further includes a means for broadcasting the TV signal. In another preferred embodiment, the multimedia signal transmission system further includes a means for multicasting the TV signal. In another preferred embodiment, the multimedia signal transmission system further includes a means for transmitting the TV signal on demand. In another preferred embodiment, the multimedia signal transmission system further includes a means for transmitting the TV signal interactively. In another preferred embodiment, the multimedia signal transmission system further includes a means for transmitting the TV signal to a mobile communication device. In another preferred embodiment, the multimedia signal transmission system further includes a means for transmitting the TV signal to a telephonic device. In another preferred embodiment, the multimedia signal transmission system further includes a means for transmitting the TV signal to a network communication device. In another preferred embodiment, the multimedia signal transmission system further includes a means for transmitting the TV signal to a personal communication device and a means for keeping account and billing a transmission of the TV signal to the personal communication device.

This invention further discloses a method for displaying a multimedia TV signal on a personal communication device that includes a step of reformatting the TV multimedia signal into a format suitable for said personal communication device. The invention further discloses a method of signal transmission that includes a step of transmitting a TV program guide to a personal communication device.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention. Those approaches and mechanisms in the art will appreciate variations of the above-described embodiments that fall within the scope of the invention. As a result, the invention is not limited to the specific examples and illustrations discussed above, but only the following claims and their equivalents.

I claim:

1. A signal transmission system comprising:
a means for transmitting a TV program guide to a personal communication device.

2. The signal transmission system of claim 1 wherein:
said means for transmitting said TV program guide to a personal communication device further includes a means for transmitting said TV program guide to a mobile phone.

3. The signal transmission system of claim 1 wherein:
said means for transmitting said TV program guide to a personal communication device further includes a means for transmitting said TV program guide to a personal digital assistant (PDA).

4. The signal transmission system of claim 1 wherein:
said means for transmitting said TV program guide to a personal communication device further includes a means for transmitting said TV program guide to a networked communication device.

5. The signal transmission system of claim 1 wherein:
said means for transmitting said TV program guide to a personal communication device further includes a means for transmitting said TV program guide to a telephonic device.

6. The signal transmission system of claim 1 wherein:
said means for transmitting said TV program guide to a personal communication device further includes a means for keeping account and billing a transmission of said TV program guide to said personal communication device.

7. A signal transmission system comprising:
a means for reformatting a TV signal into a format suitable for a personal communication device.

8. The multimedia signal transmission system of claim 7 wherein:
said means for reformatting said TV signal further include a means for reformatting said TV signal into a MPEG signal.

9. The multimedia signal transmission system of claim 7 wherein:
said means for reformatting said TV signal further include a means for reformatting said TV signal into a JPEG signal.

10. The multimedia signal transmission system of claim 7 wherein:
said means for reformatting said TV signal further include a means for reformatting said TV signal into a bit-map signal.

11. The multimedia signal transmission system of claim 7 wherein:
said means for reformatting said TV signal further include a means for reformatting said TV signal into a Real-Player signal.

12. The multimedia signal transmission system of claim 7 wherein:
said means for reformatting said TV signal further include a means for reformatting said TV signal into a Microsoft Media-Player signal.

13. The multimedia signal transmission system of claim 7 wherein:
said means for reformatting said TV signal further include a means for reformatting said TV signal into a short messaging (SMS) signal.

14. The multimedia signal transmission system of claim 7 wherein:
said means for reformatting said TV signal further include a means for reformatting said TV signal into a WAP signal.

15. The multimedia signal transmission system of claim 7 further comprising:
a means for repurposing a multimedia TV segment for wireless data transmission.

16. The multimedia signal transmission system of claim 7 further comprising:
a means for repurposing a multimedia TV segment for a preview.

17. The multimedia signal transmission system of claim 7 further comprising:
a means for repurposing a multimedia TV segment for a preview or trailer.

18. The multimedia signal transmission system of claim 7 further comprising:
a means for creating a multimedia TV segment for describing another multimedia content.

19. The multimedia signal transmission system of claim 7 further comprising:
a means for creating a text-based message for describing a multimedia content.

20. The multimedia signal transmission system of claim 7 further comprising:
a protocol means for transmitting said TV signal using a WAP protocol.

21. The multimedia signal transmission system of claim 7 further comprising:
a protocol means for transmitting said TV signal using a SMS protocol.

22. The multimedia signal transmission system of claim 7 further comprising:
a protocol means for transmitting said TV signal using a GPRS protocol.

23. The multimedia signal transmission system of claim 7 further comprising:
a protocol means for transmitting said TV signal using a CDMA1X protocol.

24. The multimedia signal transmission system of claim 7 further comprising:
a protocol means for transmitting said TV signal using a 3G (third generation) wireless protocol.

25. The multimedia signal transmission system of claim 7 further comprising:
a means for broadcasting said TV signal.

26. The multimedia signal transmission system of claim 7 further comprising:
a means for multicasting said TV signal.

27. The multimedia signal transmission system of claim 7 further comprising:
a means for transmitting said TV signal on demand.

28. The multimedia signal transmission system of claim 7 further comprising:
a means for transmitting said TV signal interactively.

29. The multimedia signal transmission system of claim 7 further comprising:
a means for transmitting said TV signal to a mobile communication device.

30. The multimedia signal transmission system of claim 7 further comprising:
a means for transmitting said TV signal to a telephonic device.

31. The multimedia signal transmission system of claim 7 further comprising:
a means for transmitting said TV signal to a network communication device.

32. The signal transmission system of claim 7 further comprising:
a means for transmitting said TV signal to a personal communication device and a means for keeping account and billing a transmission of said TV signal to said personal communication device.

33. A method for displaying a multimedia TV signal on a personal communication device comprising:
reformatting said TV multimedia signal into a format suitable for said personal communication device.

34. A method for signal transmission comprising:
transmitting a TV program guide to a personal communication device.

35. The method of claim 34 wherein:
said step of transmitting said TV program guide to a personal communication device further includes a step of transmitting said TV program guide to a mobile phone.

36. The method of claim 34 wherein:
said step of transmitting said TV program guide to a personal communication device further includes a step of transmitting said TV program guide to a personal digital assistant (PDA).

37. The method of claim 34 wherein:
said step of transmitting said TV program guide to a personal communication device further includes a step of transmitting said TV program guide to a networked communication device.

38. The method of claim 34 wherein:
said step of transmitting said TV program guide to a personal communication device further includes a step of transmitting said TV program guide to a telephonic device.

39. The method of claim 34 wherein:
said step of transmitting said TV program guide to a personal communication device further includes a step of keeping account and billing a transmission of said TV program guide to said personal communication device.

40. The method of claim 34 wherein:
said step of transmitting said TV program guide to a personal communication device further includes a step of controlling and navigating a multimedia display device using said TV program guide received by said personal communication device.

41. The method of claim 34 wherein:
said step of transmitting said TV program guide to a personal communication device further includes a step of sending a wireless signal from said personal communication device for controlling and navigating a multimedia display device using said TV program guide received by said personal communication device.

42. The method of claim 34 wherein:
said step of transmitting said TV program guide to a personal communication device further includes a step of controlling a multimedia display device for displaying said TV program guide received by said personal communication device on said multimedia display device.
